(19) United States
(12) Patent Application Publication
(10) Pub. No.: US 2023/0250848 A1
(43) Pub. Date: Aug. 10, 2023

(54) INTEGRAL HAMMER FOR THE ASSEMBLY OF SOWING DISCS OF A SEEDING MACHINE

(71) Applicant: BPB Mediterranea S.A., Villa Maria (AR)

(72) Inventor: Gustavo Alejandro BOETSCH, Villa Maria (AR)

(21) Appl. No.: 18/146,413

(22) Filed: Dec. 26, 2022

(30) Foreign Application Priority Data
Feb. 7, 2022 (AR) 20220100245

(51) Int. Cl. F16C 19/38; A01B 35/28; A01C 5/06

(52) U.S. Cl. CPC F16C 19/386; A01B 35/28; A01C 5/064; F16C 2310/00

(57) ABSTRACT

An integral hammer (M) designed for the assembly of a sowing disc (D) which is fixed with the bolts (22) and nuts (23) is described. It stands out due to the fact that it includes machining on its internal face of a first raceway (10) and a second raceway (11) for the direct assembly of a first conical roller (12) and a second conical roller (13), thus eliminating the need to incorporate the cups that make up conventional bearings from the outset. For the assembly of said first conical roller (12) and second conical roller (13), the first internal cone (14) and a second internal cone (15) that define the inner bearing rings are used. In this way, the integral hammer works as a single unit that includes the aforementioned first internal cone (14) and a second internal cone (15) with their respective first cage (16) and second cage (17) constituting the hammer-bearing set.

### CROSS REFERENCE TO RELATED APPLICATIONS

This application claims priority from Argentinean application number 20220100245 filed on Feb. 7, 2022, which is incorporated herein by referenced in its entirety.

### FIELD OF THE INVENTION

The present invention, for which the registration of a Utility Model is requested, has as its main object an INTEGRAL HAMMER FOR THE ASSEMBLY OF SOWING DISCS OF A SEEDING MACHINE, specially designed to optimize the mounting of the parts involved in the assembly of the discs in the sowing bodies, and facilitate their replacement.

More specifically, the present invention refers to a new integral hammer for the assembly of sowing discs, whose body has been specially modified to define a disc-bearing hammer in which the bearing tracks are machined and rectified, forming a unit which is shielded and maintenance free.

### BACKGROUND

The advantage of this new embodiment is that the mounting of the set is optimized and its replacement is facilitated.

It also has a greater load capacity because its configuration allows the use of a double row of conical rollers, which provides greater stability due to the angular contact that occurs when they are assembled back-to-back.

Indeed, with the incorporated modification, the load capacity of the set is increased since the number of rollers in contact is adequate. On the other hand, the conical rollers are already assembled and shielded by means of specific seals, thus constituting a shielded unit that already includes the quantity and type of grease suitable for the application, taking into account that said assembly was in a prepared environment and free of any contamination, therefore the useful life is increased due to better conditions of the lubricant.

This is a new provision obtained on known objects that imports a better use in the function for which they are intended. Consequently, said new provision may be protected under the concept of Utility Model established by the Invention patent Law in its articles 53 to 58.

Two radial ball bearings or two tapered roller bearings are currently used for the assembly of the sowing disc, which are assembled on the body of the hammer. To do this, a retainer is placed and the whole set is then assembled on the planting body.

The problem is that in no case is it possible to guarantee the correct assembly, nor the final radial-axial play. Likewise, the assembly of the aforementioned retainer is a critical point, since it is susceptible to failures due to incorrect assembly, which ends up affecting the useful life of the set.

### SUMMARY OF THE INVENTION

The constructive modification that the hammer of this invention incorporates lies in the fact that it includes the machined tracks in its own body, from which it is possible to carry out the exact adjustment of the set that is used for the assembly of the sowing disc, with the axial play necessary, without having to be adjusted by the user.

With the incorporated modification, a hammer body is formed that has the raceways machined inside for the conical rollers that the assembly requires, so that the hammer body works as a single set. Then, on both sides, the respective inner rings of the bearings and the corresponding cage are incorporated, thus forming the hammer-bearing set.

With this new shape of the hammer body, it is possible to precisely adjust the axial play of the set, which, with the inclusion of the lubricant and the corresponding seals, forms a sealed, maintenance-free unit.

It is then highlighted that the novelty incorporated in the integral hammer of the present invention lies in the fact that the bearing is part of the hammer. It is a new maintenance-free configuration of pre-adjusted and armored conical rollers.

The advantages obtained lie in
Greater load capacity of the set.
Better shielding, resulting in improved service life.
Significantly facilitates assembly as no end-play adjustment is required
Longer useful life of the set.

### BRIEF DESCRIPTION OF THE DRAWINGS

In order to specify the advantages thus briefly commented, to which users and those skilled in the art may add many more, and to facilitate the understanding of the constructive, constitutive and functional characteristics of the integral hammer invented, an example preferred embodiment is described below which is illustrated, schematically and without a specific scale, in the attached sheets, with the express clarification that, precisely because it is an example, it is not appropriate to assign it a limiting or exclusive nature of the scope of protection of the present invention, but rather it is simply assisted by a merely explanatory and illustrative intention of the basic conception on which it is based.

FIG. 1 is representative of the prior art, which shows in cross-section the body of a hammer with the pair of coupled bearings that is currently used for the assembly of a sowing disc.

FIG. 2 is also a vertical sectional view which, in this case, represents the modified hammer according to this invention with the set of parts that are incorporated for the assembly of the sowing disc.

FIG. 3 is an exploded perspective view showing the same combination of elements that is used for the assembly of the sowing disc with the hammer of this invention.

FIG. 4 is a perspective view of the integral hammer body of this invention.

FIG. 5 is a vertical sectional view of the same hammer body of the previous Figure.

It is clarified that, in all the figures, the same reference numbers and letters correspond to the same or equivalent parts or constituent elements of the set, according to the example chosen for the present explanation of the invented integral hammer.

### DETAILED DESCRIPTION

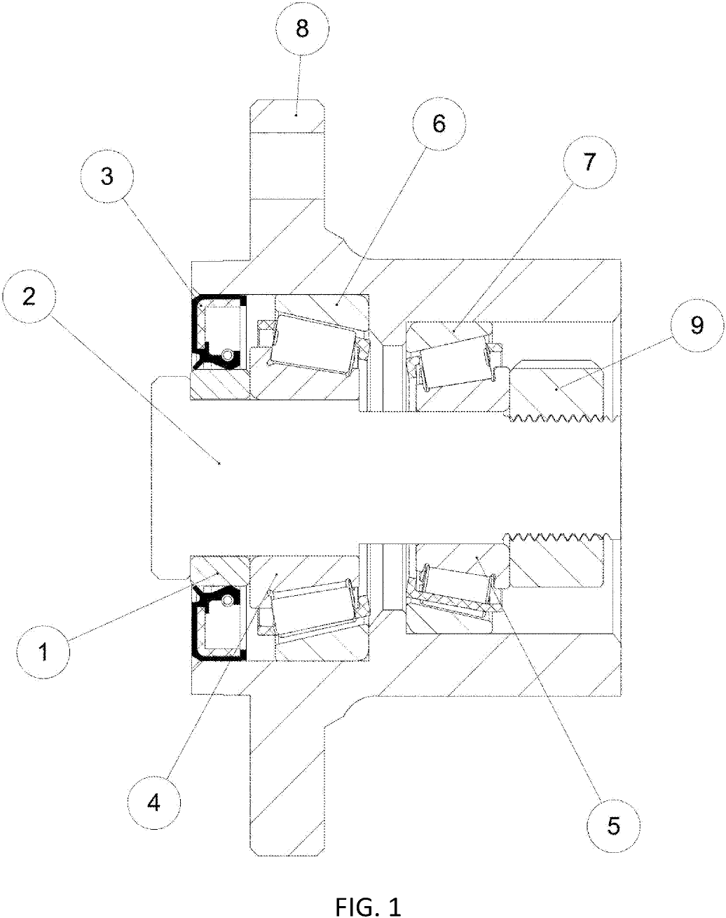

FIG. 1 shows how the set for the assembly of the disc of the sowing disc is formed. In these known embodiments, it can be seen that the cups of the conical bearings (6) and (7) are housed inside the hammer body (8). For its assembly, first the cone (4) is incorporated on the internal side, with the corresponding retainer (3), then a hardened bushing (1) is placed, which has the function of being the track wherein the lip of the retainer (3) makes contact, this is due to the fact that the shaft (2) wherein the set is assembled is soft, and the friction of the lip of the retainer would wear it out prematurely, for this reason said hardened bushing (1) is used.

Under the exposed conditions, in order to produce the assembly, the hammer body is greased, by applying the necessary amount of grease, this raises the problem that the lubricant may become contaminated, since the environment where this process is usually carried out is not normally the suitable, which affects the service life of the bearing.

Once the greasing is complete, the cone (5) is placed on the external side and the set is adjusted by placing the nut (9) that is screwed onto the mounting shaft (2). This is a critical and complex process, since it requires giving the set the proper adjustment to avoid overloading the tracks, either due to excessive adjustment, or excessive axial clearance due to poor adjustment.

It should be noted that with the assembly mentioned in the preceding paragraphs, the load capacity of the bearings is affected, since if the adjustment is excessive, the force produced between the rolling elements and the raceways takes on such high values that it leads to breakage of the set (due to exceeding the admissible load limit value of the material), raising the temperature of the set, damaging the grease and the retainer rubber.

On the contrary, if a lower load than required is applied, the excessive internal clearance affects the number of rollers in contact, so the force exerted on the set is supported by fewer rollers, therefore, the bearing load capacity is reduced.

It can be seen that the disadvantage of this assembly lies in the fact that there are too many factors to consider when assembling the set, which requires that the person who carries out the work has a lot of experience in the specialty, which is not very common.

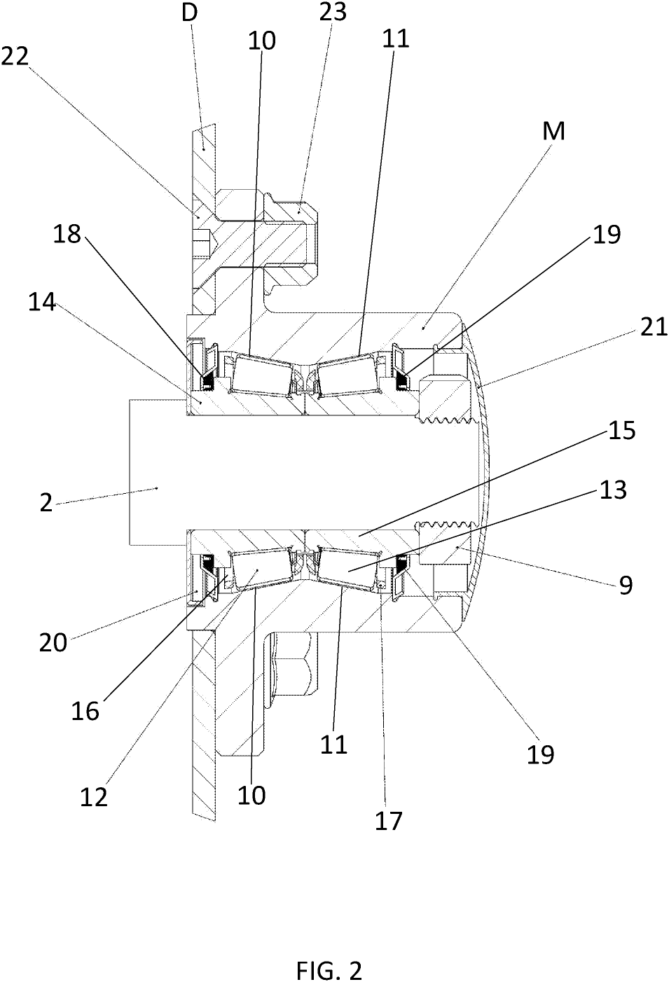

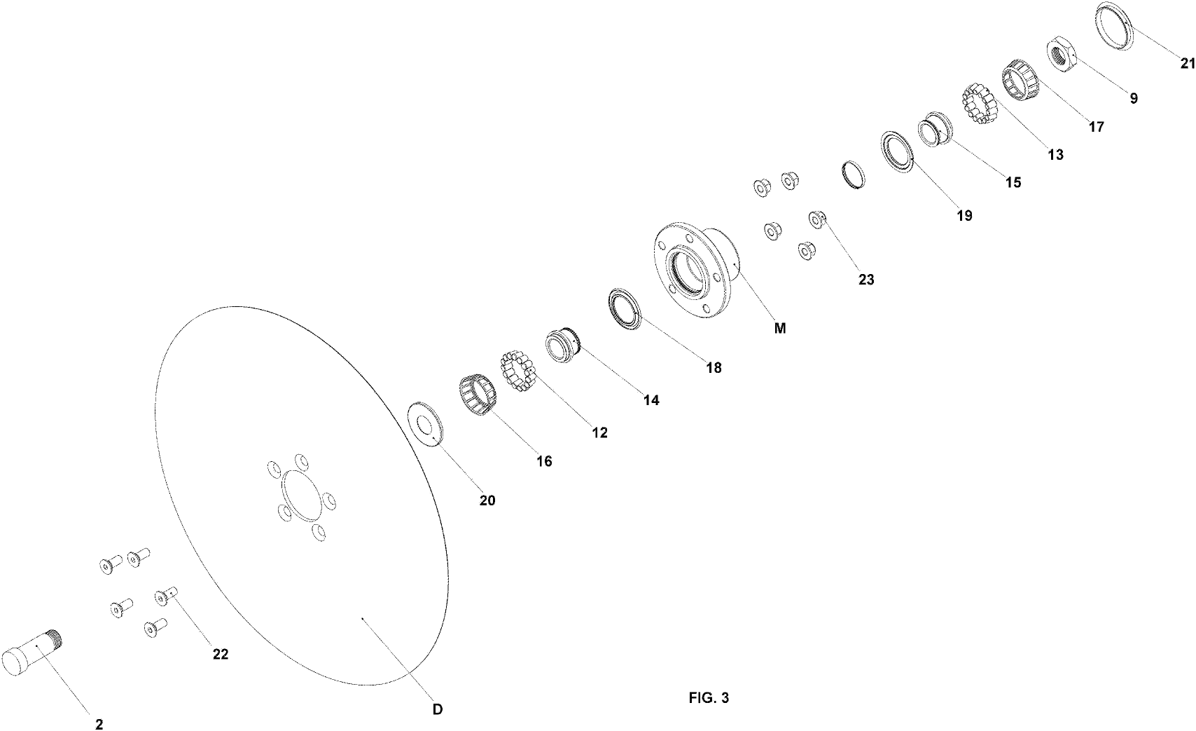

As FIGS. 2 and 3 especially show, the integral hammer to which this invention refers and is identified with the reference (M), is also provided for the assembly of the sowing disc (D) that is fixed with the bolts (22) and nuts (23), and is distinguished by the fact that it includes machining on its inner face of the a first raceway (10) and a second raceway (11) for the direct assembly of a first conical roller (12) and a second conical roller (13), thus eliminating the need to incorporate the cups that make up conventional bearings.

The same FIGS. 2 and 3 show that for the assembly of the referred the first conical roller (12) and second conical roller (13), the first internal cone (14) and a second internal cone (15) that define the inner bearing rings are used.

Consequently, the integral hammer (M) of this invention works as a single unit that includes the aforementioned first internal cone (14) and a second internal cone (15) with their respective first cage (16) and second cage (17) constituting the hammer-bearing set.

In order to keep the interior of the set lubricated, a first seal (18) and a second seal (19) are used, thus forming a sealed unit, all of which is fixed on the shaft (2) wherein the mechanical seal (20) was previously assembled, it is fixed to the shaft by means of adjusting the nut (9) and the cap (21).

It can be seen that an extremely simple assembly is achieved, since it is not necessary to ensure the play during assembly, the direct adjustment that is made with the nut (9) adjusted to the stop is sufficient.

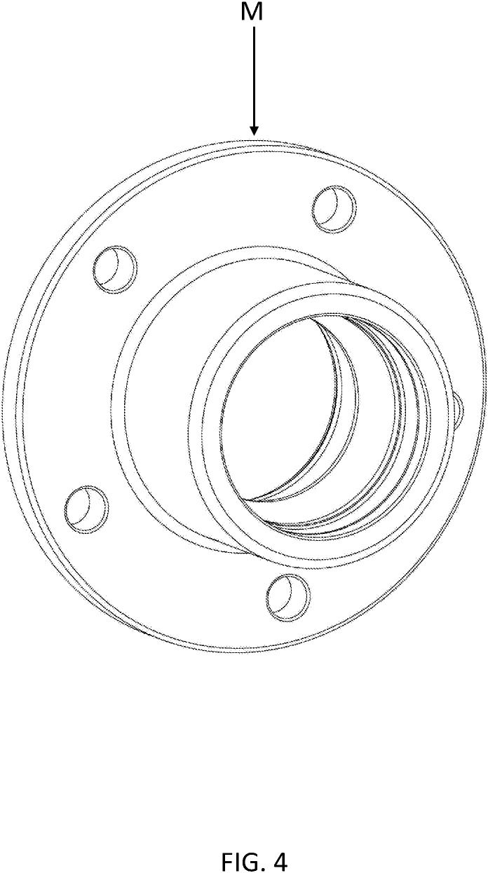

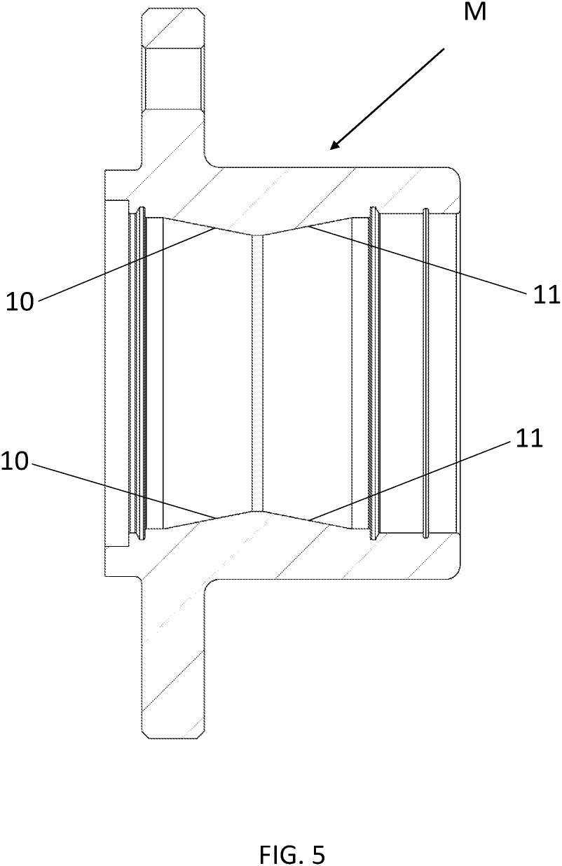

Finally, looking now at FIGS. 4 and 5, it is possible to clearly appreciate the constructive modification that highlights the integral hammer (M) of this invention which, as stated above, includes a first raceway (10) and a second raceway (11) on its internal surface, wherein the first conical roller (12) and a second conical roller (13) sit (visible in FIGS. 2 and 3), thus eliminating the need to incorporate bearings from the outset.

What is claimed is:

1. An integral hammer for the assembly of sowing discs of a seeding machine, comprising:
a first raceway and a second raceway for the direct assembly on a first conical roller and a second conical roller, wherein said first conical roller and second conical roller rest on a first internal cone and a second internal cone that define the inner bearing rings.

2. The integral hammer of claim 1, wherein said first internal cone and second internal cone fit within a first cage and second cage.

3. The integral hammer of claim 1, further comprising a first seal and a second seal.
